(19) United States
(12) Patent Application Publication
(10) Pub. No.: US 2014/0099393 A1
(43) Pub. Date: Apr. 10, 2014

(54) APPARATUS FOR CONTINUOUSLY EXTRUDING POLYMER RESIN

(71) Applicant: THE INDUSTRY & ACADEMIC COOPERATION IN CHUNGNAM NATIONAL UNIVERSITY (IAC), Daejeon (KR)

(72) Inventor: Kee-Yoon Lee, Daejeon (KR)

(73) Assignee: THE INDUSTRY & ACADEMIC COOPERATION IN CHUNGNAM NATIONAL UNIVERSITY (IVC), Daejeon (KR)

(21) Appl. No.: 14/001,921

(22) PCT Filed: Nov. 7, 2012
(86) PCT No.: PCT/KR2012/009295

§ 371 Date: Aug. 28, 2013

(30) Foreign Application Priority Data
Oct. 5, 2012 (KR) 10-2012-0110514

(51) Int. Cl. B29C 47/94

(52) U.S. Cl. CPC B29C 47/94
USPC 425/95

(57) ABSTRACT

The present invention relates to an apparatus for continuously extruding polymer resin, and more particularly, to an apparatus for continuously extruding polymer resin melts in a direction parallel with a flow direction thereof, in which a lubricant injected through an oil injection port formed on an extrusion die flows along an inner circumferential surface of an extrusion path so as to move along with the polymer resin melts.

### TECHNICAL FIELD

The present invention relates to an apparatus for continuously extruding polymer resin, and more particularly, to an apparatus for continuously extruding polymer resin melts in a direction parallel with a flow direction thereof, in which a lubricant injected through an oil injection port formed on an extrusion die flows along an inner circumferential surface of an extrusion path so as to move along with the polymer resin melts.

### BACKGROUND ART

Extrusion is a machining method for manufacturing a bar or a pipe having various shapes of sections by melting soft metal such as aluminum and magnesium or various types of thermoplastic polymer resins (molding material) in a barrel and pushing the melted soft metal to an extrusion port so that the corresponding molded material has a section corresponding to a hole shape of the extrusion port.

A method for extruding metal and a method for extruding thermoplastic polymer are basically different from each other in terms of a basic theory, and therefore only the method for extruding thermoplastic polymer will be described herein.

A kind of an extrusion apparatus for the extrusion machining is very various. In general, the extrusion device includes a cylindrical barrel longitudinally extending so as to press and transfer the molded material and an extrusion screw rotating based on a shaft in the barrel and transferring the melted polymer resin. Further, at least one extrusion screw may be included in the extruder.

In the extrusion process using resin as the molded material, only one thermoplastic resin may also be used as the molded material; in most cases, however, a quality of the product can be improved by maximizing physical chemical features included in each resin using various kinds of thermoplastic resins.

In this case, a ratio or a combination of the thermoplastic resins injected into the extrusion device may vary according to kinds or physical properties of targeted products. Further, resins may chemically react to each other in the melted state in the extruding device and may keep only a mixed state therein.

Korean Patent Laid-Open Publication No. 2010-0067614 (published on Jun. 21, 2010 entitled ‘extruder’) discloses an extrusion screw for a plastic melt or natural or artificial rubber mixture.

Meanwhile, a process of continuously extruding polymer according to the related art may be carried out only at resin temperature higher than a melting temperature Tm of resin in case of a crystalline polymer or temperature higher than transition temperature Tg in case of amorphous polymer. The reason is that a resin is solidified and stuck on an inner surface of a die under the low resin temperature, and thus the continuous operation cannot be carried out.

Further, the continuous extrusion cannot be performed under the hard working environment in which the viscosity of resin is very high or the resin is solidified, thereby degrading productivity.

Therefore, in order to solve the foregoing problems, the development of an extrusion apparatus and an extrusion method is urgently needed.

### DISCLOSURE

### Technical Problem

An exemplary embodiment of the present invention is directed to an apparatus for continuously extruding polymer resin capable of evenly coating a lubricant on a surface of a polymer resin melts by moving a lubricant injected through an oil injection port disposed above an extrusion die along an inner circumferential surface of an extrusion path so as to move along with the polymer resin melt.

Another exemplary embodiment of the present invention is directed to an apparatus for continuously extruding polymer resin capable of easily extruding polymer resin and simply removing a lubricant injected after extrusion by injecting the lubricant performing a lubrication action on a surface of polymer and coating the surface of polymer so as to facilitate extrusion of polymer resin.

Still another exemplary embodiment of the present invention is directed to an apparatus for continuously extruding polymer resin capable of easily extruding polymer resin by coating a lubricant acting as lubrication coating into a die so as to coat a surface of an extrusions so as to carry out extrusion of polymer resin melts having very high viscosity and low-temperature extrusion, in which the injected organic and inorganic lubricants generate a fluid flow forming two phases without being mixed in the extrusions.

### Technical Solution

An exemplary embodiment of the present invention provides an apparatus 1 for continuously extruding polymer resin in a direction parallel with a flow direction thereof, including: an extruder 100 including a barrel 140 having a hopper 110 disposed at one part thereof and an extrusion port 141 disposed at the other end thereof and an extrusion screw 130 rotatably disposed about a rotation shaft in the barrel 140 and; and an extrusion die 200 connected with the extruder 100 so as to be injected with the polymer resin melts from the extruder 100 and discharging the polymer resin melts to a nozzle portion 300 through an extrusion path 221 formed by penetrating through the inside of the extrusion die 200, wherein a lubricant injected through an oil injection port 211 formed in the extrusion die 200 flows along an inner circumferential surface of the extrusion path 221 to move along with the polymer resin melts.

The extrusion die 200 may include: a die body 210 including the oil injection port 211 disposed at one part thereof and a through hole 212 disposed therein and penetrated in a flow direction of the polymer resin melts; a body insertion portion 220 formed in a cylindrical pipe shape to be inserted and coupled into the through hole 212 of the die body 210 and having the extrusion path 221 disposed therein, an oil flowing portion 222 formed to be radially depressed in a predetermined region of an outer circumferential surface, centered on a position at which the oil injection port 211 is formed, and an oil flowing hole 223 formed by making both ends of the oil flowing portion 222 in a hollow shape to move the oil to the extrusion path 221; and a neck portion 230 including a communication hole 231 formed to penetrate through the inside thereof so as to communicate the extrusion port 141 of the extruder 100 with the extrusion path 221, having one part coupled with the extrusion port 141 of the extruder 100 and the other part coupled with one end of the body insertion portion 220.

The oil flowing portion 222 may be adjacently formed to one end of the body insertion portion 220 disposed at a portion connected with the neck portion 230.

An area in which the neck portion 230 is coupled with one end of the body insertion portion 220 may be provided with a connection portion 232.

The extrusion path 221 may be formed to have a diameter gradually reduced from an area in which the oil flowing hole 223 is formed and a diameter constantly kept from an area in which an end of the connection portion 232 is disposed so as to correspond to the shape of the connection portion 232.

The apparatus 1 for continuously extruding polymer resin may further include an oil pump 400 inserted and coupled into the oil injection port 211 to supply oil at a predetermined pressure.

The oil pump 400 may be a gear pump or a plunger pump.

The lubricant may be water, silicon oil, ethylene glycol, canola oil, oligomer, or synthetic oil.

### Advantageous Effects

According to the exemplary embodiments of the present invention, the apparatus for continuously extruding polymer resin can move the lubricant injected through the oil injection port formed above the extrusion die along the inner circumferential surface of the extrusion path so as to move along with the polymer resin melts so as to evenly coat the lubricant on the surface of the polymer resin melt, thereby carrying out the continuous process.

Further, the apparatus for continuously extruding polymer resin can carry out the extrusion of the polymer resin melts having very high viscosity while carrying out the extrusion in the vicinity of the transition temperature of polymer resin or at the transition temperature or lower.

Further, according to the exemplary embodiments of the present invention, the apparatus for continuously extruding polymer resin can carry out the continuous extrusion from the extrusion die in the vicinity of the melting temperature of polymer resin or at the melting temperature or lower, save the energy fuel costs in response to the reduction in extrusion pressure and torque, reduce the manufacturing costs, and reduce the generation of carbon dioxide.

In addition, the apparatus for continuously extruding polymer resin can improve the physical properties of the final extrusions since the resin temperature within the extruder does not need to be kept at the melting temperature or higher and can variously change the die shape by reducing the die swell that is a decisive variable of the final extrusions.

In summary, according to the exemplary embodiments of the present invention, the apparatus for continuously extruding polymer resin can facilitate the continuous extrusion of the polymer resin melts, carry out the extrusion even though a viscosity of a melt is very high, prevent the physical properties of polymer from being degraded due to the deterioration by implementing the low-temperature extrusion, and continuously extrude the polymer resin by remarkably reducing the pressure of the extruder.

### DESCRIPTION OF DRAWINGS

FIG. 1 is a configuration diagram schematically illustrating an apparatus for continuously extruding polymer resin according to an exemplary embodiment of the present invention.

FIG. 2 is an exploded perspective view illustrating an extrusion die in an apparatus for continuously extruding polymer resin according to the exemplary embodiment of the present invention.

FIG. 3 is a perspective view illustrating the extrusion die in the apparatus for continuously extruding polymer resin according to the exemplary embodiment of the present invention.

FIG. 4 is a side view illustrating the extrusion die in the apparatus for continuously extruding polymer resin according to the exemplary embodiment of the present invention.

FIG. 5 is a plan view illustrating the extrusion die in the apparatus for continuously extruding polymer resin according to the exemplary embodiment of the present invention.

FIG. 6 is a schematic diagram illustrating a path through which oil flows and a path through which polymer resin melts flow, in the apparatus for continuously extruding polymer resin according to the exemplary embodiment of the present invention.

FIG. 7 is a graph illustrating a rate distribution in an extrusion method according to the related art.

FIG. 8 is a graph illustrating a shear rate distribution in the extrusion method according to the related art.

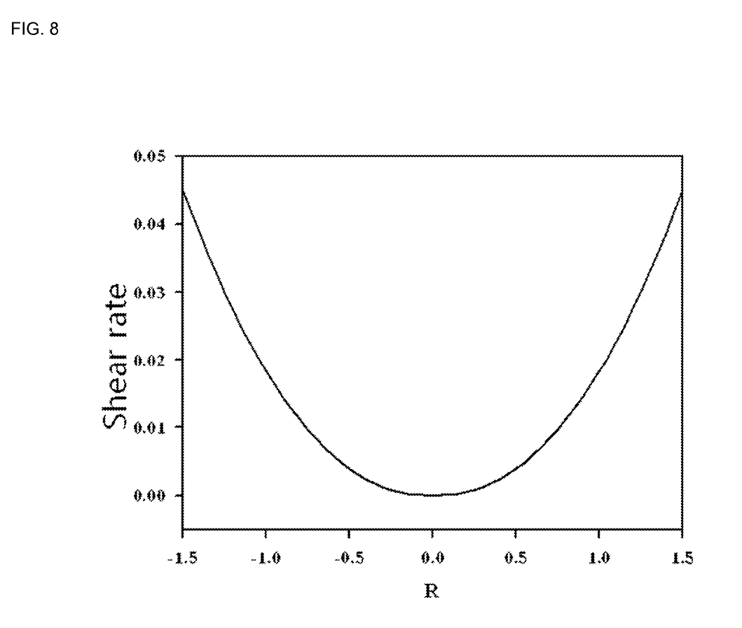

FIG. 9 is a graph illustrating a rate distribution in the apparatus for continuously extruding polymer resin according to the exemplary embodiment of the present invention.

FIG. 10 is a graph illustrating a shear rate distribution in the extrusion method according to the related art in the apparatus for continuously extruding polymer resin according to the exemplary embodiment of the present invention.

### BEST MODE

Hereinafter, an apparatus for continuously extruding polymer resin and a continuous extruding method using the same according to exemplary embodiments of the present invention will be described with reference to the accompanying drawings.

First, an apparatus 1 for continuously extruding polymer resin according to an exemplary embodiment of the present invention is to continuously extrude polymer resin melts in a direction parallel with a flow direction thereof and may be configured to largely include an extruder 100 and an extrusion die 200.

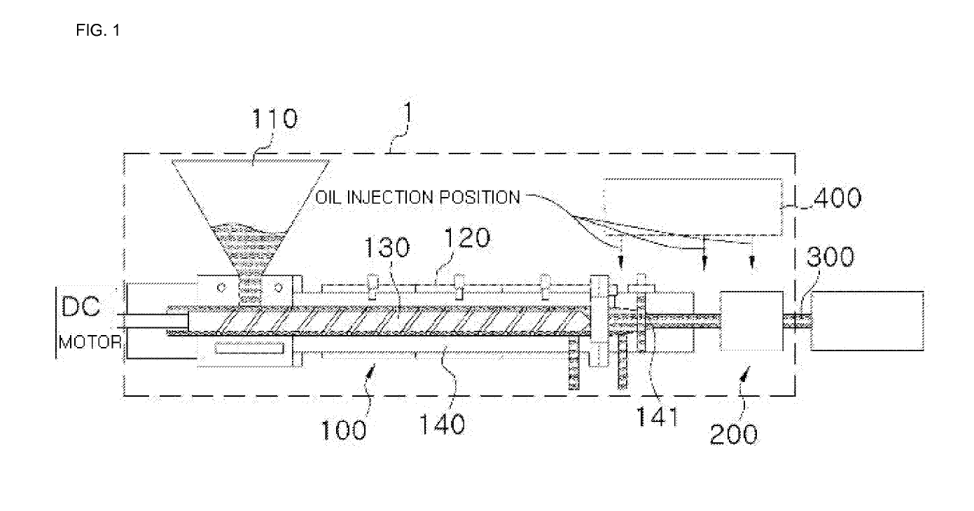

As illustrated in FIG. 1, the apparatus 1 for continuously extruding polymer resin may include a cooler or a calibrator disposed at a latter stage of the extrusion die 200. Further, the exemplary embodiment of the present invention is applied to a configuration in which a crosslinking device is not disposed in a latter stage of the extrusion die 200, that is, an extrusion process that is not crosslinked.

However, the apparatus 1 for continuously extruding polymer resin may also be applied to a working of rubber compound that does not directly connect the crosslinking device with the latter stage thereof.

As illustrated in FIG. 1, the extruder 100 is configured to include a barrel 140 that includes a hopper 110 disposed at one part thereof and an extrusion port 141 disposed at the other end thereof and an extrusion screw 130 rotatably disposed about a rotation shaft in the barrel 140.

Further, the inside of the barrel 140 is provided with a heater 120 melting polymer resin.

The extrusion die 200 is connected with the extruder 100 so as to be injected with the polymer resin melts from the extruder 100 and discharges the polymer resin melts to a nozzle portion 300 through an extrusion path 221 formed by penetrating through the inside of the extrusion die 200.

In this configuration, the apparatus 1 for continuously extruding polymer resin is configured to move a lubricant injected through an oil injection port 211 disposed above the extrusion die 200 along an inner circumferential surface of the extrusion path 221 not to be mixed with the polymer resin melts and coat on a surface of the polymer resin melts while moving along with the polymer resin melts.

An example of the lubricant may include water, silicon oil, ethylene glycol, various oligomers such as canola oil, synthetic oil, or the like. In particular, the lubricant preferably uses materials having smaller viscosity than polymer resin at the time of extrusion machining and at the time of the extrusion working, in case of polypropylene, the viscosity is about 300 Pa s at a shear rate of 100 s⁻¹, and therefore any organic material, inorganic material, or oligomer that has viscosity of 300 Pa s or less can be used without being limited.

More preferably, any poor solvent, including water is used without being limited. More preferably, an organic/inorganic coating agent having a viscosity of 500 Pa s (=about 505 mm²/s) or less may be used. As the organic/inorganic coating agent, silicon oil, ethylene glycol, various oligomers such as canola oil, synthetic oil, or the like may be used and in case of using water, a cooling process using cooling water in a post-process has been generally used, and therefore the post-processing such as a washing process is not required. As a result, it is more preferable to use water.

When a viscosity of the organic/inorganic coating agent exceeds 500 Pa s, the viscosity is generally higher than polymer melting viscosity, such that the organic/inorganic coating agent does not flow between the polymer resin melts and an inner circumferential surface of the extrusion die 200 but tends to move to a central part of a fluid. As a result, the viscosity of the organic/inorganic coating agent is preferably in a range of 500 Pa s or less.

Therefore, the apparatus 1 for continuously extruding polymer resin according to the exemplary embodiment of the present invention can carry out the continuous extrusion of the polymer resin melts and the low-temperature extrusion to prevent the degradation in physical properties of polymer due to the degradation and can surprisingly reduce the pressure of the extruder 100 to continuously extrude the polymer resin.

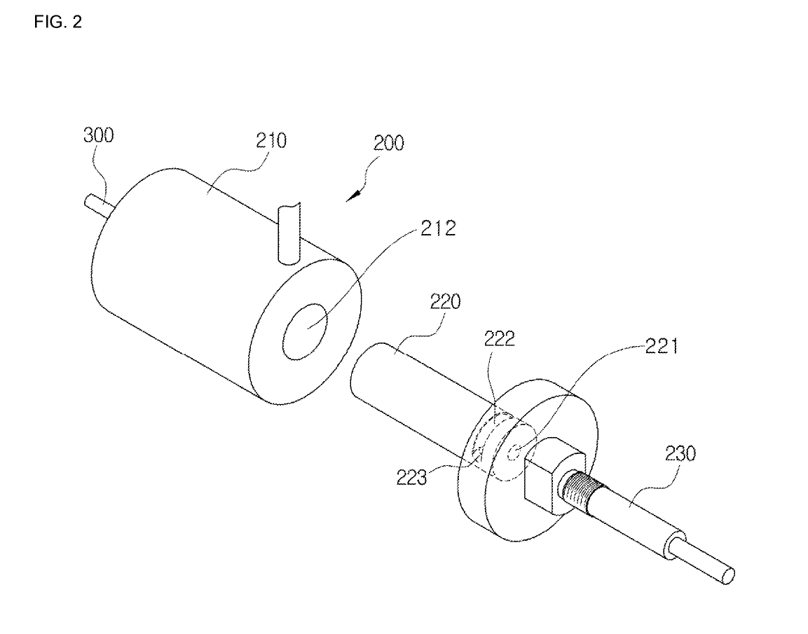

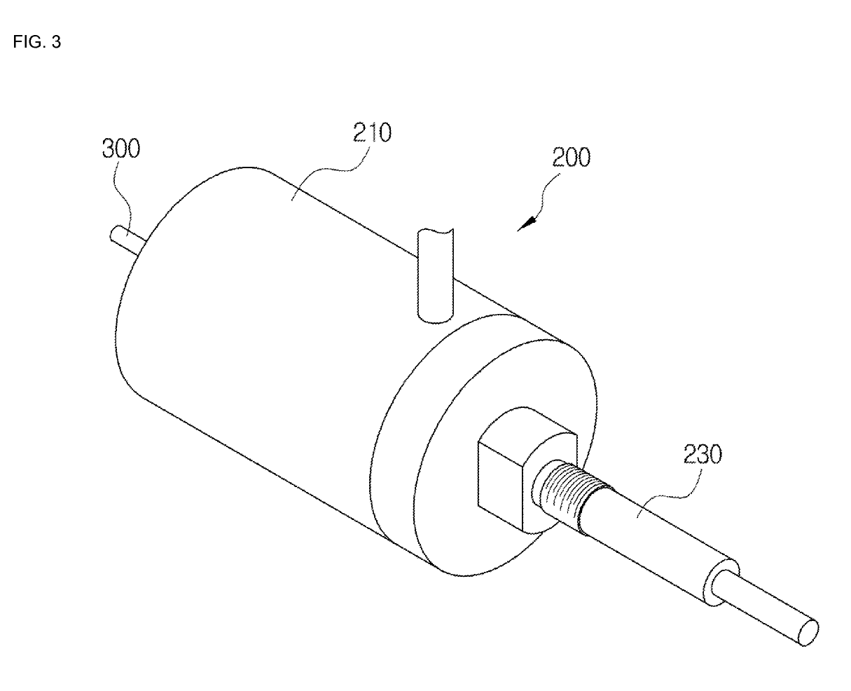

In more detail, as illustrated in FIGS. 2 to 5, the extrusion die 200 may be configured to largely a die body 210, a body insertion portion 220, and a neck portion 230.

In order to solve the problem that the extrusions cannot be stably obtained due to the working instability when the lubricant is injected in only one direction, the apparatus 1 for continuously extruding polymer resin according to the exemplary embodiment of the present invention includes the oil injection port 211 that injects oil in at least two directions and then evenly coat the oil on the surface of the polymer resin melts and the structure thereof will be described below.

The die body 210 is configured to include the oil injection port 211 disposed abovethere and a through hole 212 penetrated in a flow direction of the polymer resin melts and disposed therein.

The body insertion portion 220 has a cylindrical pipe shape so as to be inserted into the through hole 212 of the die body 210. Further, the body insertion portion 220 has the extrusion path 221 longitudinally extending therein and an oil flowing portion 222 radially depressed along an outer circumferential surface, centered on a position at which the oil injection port 211 is formed, and an oil flowing hole 223 formed by making both ends of the oil flowing portion 222 in a hollow shape to move the lubricant to the extrusion path 221.

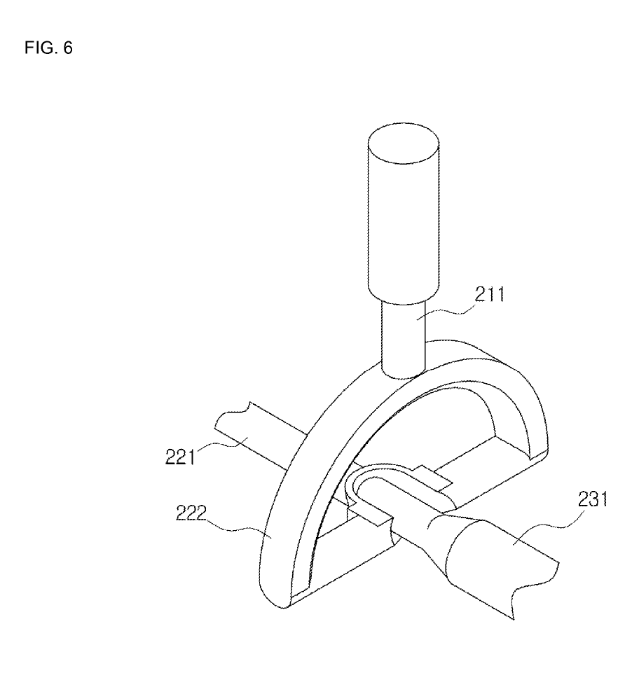

FIG. 6 schematically illustrates a path through which a lubricant is injected from the outside along the oil flowing portion 222 and the oil flowing hole 223 formed on the body insertion portion 220.

As illustrated in FI. 6, the lubricant flows into the extrusion path 221 along the oil flowing portion 222 through the oil flowing hole 223 and moves along with the polymer resin melts while evenly coating the surface of the polymer resin melts.

The neck portion 230 includes a communication hole 231 formed to penetrate through the inside thereof so as to communicate the extrusion port 141 of the extruder 100 with the extrusion path 221 and one part thereof is coupled with the extrusion port 141 of the extruder 100 and the other part thereof is coupled with one end of the body insertion portion 220.

In this configuration, in the apparatus 1 for continuously extruding polymer resin according to the exemplary embodiment of the present an area in which the oil flowing portion 222 is formed may be preferably formed to be adjacent to one end of the body insertion portion 220 that is disposed at a portion which is connected with the neck portion 230. In addition to this, the lubricant may also be injected into at least one of the extrusion port 141, the neck portion 230, and the extrusion die 200 as illustrated in FIG. 1.

Meanwhile, the body insertion portion 220 may be provided with the plurality of oil injection ports 211. In this case, the oil flowing portion 222 is depressed along the outer circumferential surface so as to pass through a position at which the oil injection port 211 is formed and may be provided with at least two oil flowing holes 223.

Therefore, the lubricant may more evenly coat the outer circumferential surface of the polymer resin melts.

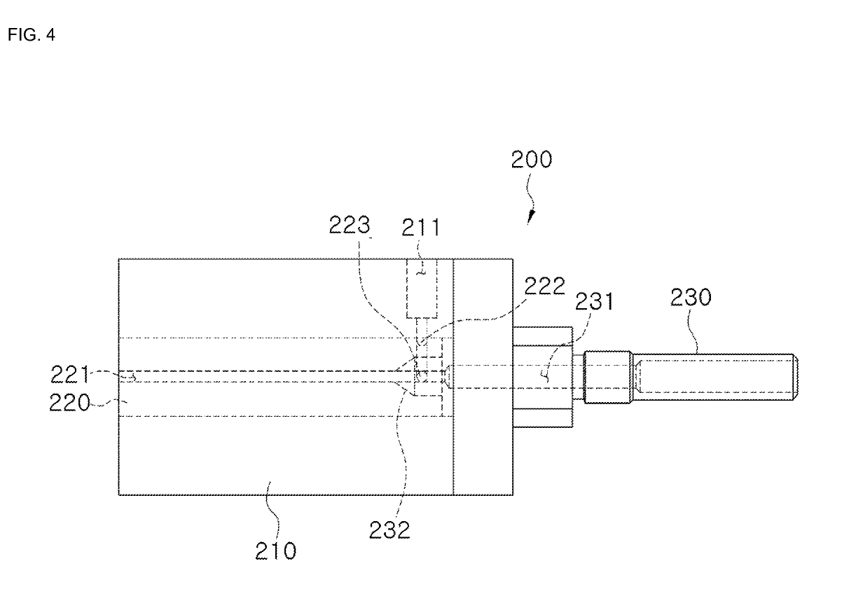

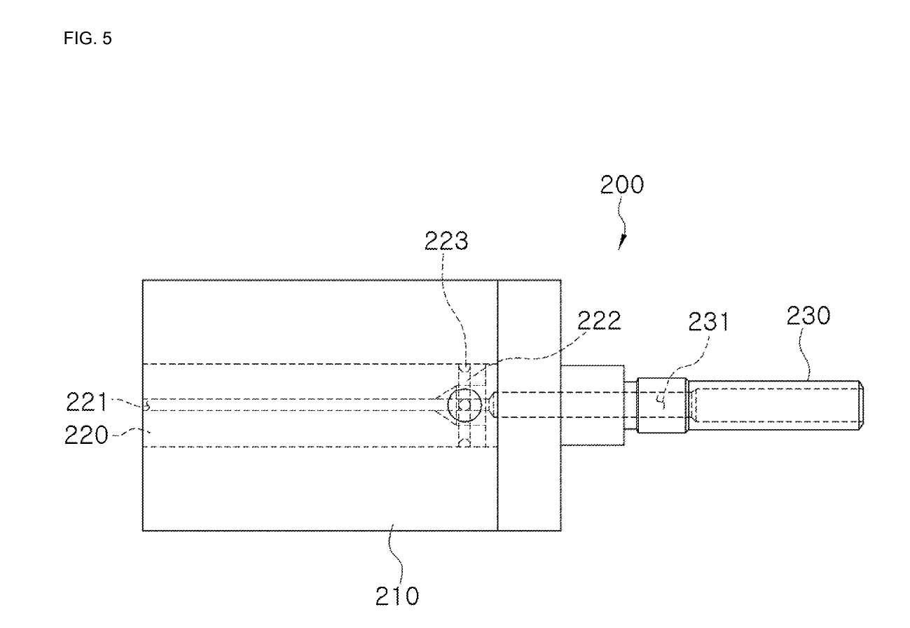

As illustrated in FIGS. 4 and 5, the area in which the neck portion 230 is coupled with one end of the body insertion portion 220 may be further provided with a connection portion 232 of which the diameter is getting narrower.

Therefore, the extrusion path 221 may be formed to have a diameter gradually reduced from an area in which the oil flowing hole 223 is formed and a diameter constantly kept from an area in which an end of the connection portion 232 is disposed to the other end in order that the area in which the extrusion path 221 is coupled with the neck portion 230 corresponds to the shape of the connection portion 232.

In the apparatus 1 for continuously extruding polymer resin according to the exemplary embodiment of the present invention, the body insertion portion 220 may be inserted into the die body 210 and then fixed therein by being cooled at normal temperature or low temperature in the state in which the die body 210 is applied with heat to expand the through hole 212 so that the body insertion portion 220 coupled with the neck portion 230 may be inserted and coupled into the die body 210.

In addition to this, in the apparatus 1 for continuously extruding polymer resin according to the exemplary embodiment of the present invention, various methods for coupling the body insertion portion 220, the die body 210, and the neck portion 230 one another may be used.

Meanwhile, the apparatus 1 for continuously extruding polymer resin according to the exemplary embodiment of the present invention may be configured to include an oil pump 400 that is inserted and coupled into the oil injection port 211 to supply oil with a predetermined pressure.

The oil pump 400 may be a gear type of gear pump or a plunger type of plunger pump. The neck portion 230 or the extrusion die 200 of the extruder 100 is a portion at which a resin pressure reaches substantially the highest point, about 100 to 500 bar, such that the pressure of the oil pump 400 is above the resin pressure.

Further, when a low-temperature lubricant is injected into the oil pump 400, the extrusion process is instable and thus the continuous extrusion working is impossible, such that it is preferable to adjust a temperature difference between temperature of resin and temperature of a lubricant to 50° C. or less.

Describing the case in which the oil pump 400 is a gear pump, in the apparatus 1 for continuously extruding polymer resin according to the exemplary embodiment of the present invention, a groove of a gear is filled with a lubricant due to the gear engagement and suction at an inlet of the oil pump 400 and the lubricant is forcibly transferred and in case of the plunger pump, the lubricant is forcibly transferred by a reciprocating movement of the plunger.

In this case, when a space formed by a gear casting and a plate is filled with a lubricant, the lubricant moves to an outlet along an inner circumference of a casing and the lubricant at the outlet may flow due to the gear engagement and flows in the extrusion die 200 along a pipe formed of a stainless material and connected with the outlet through the oil injection port 211 and the oil flowing hole 223.

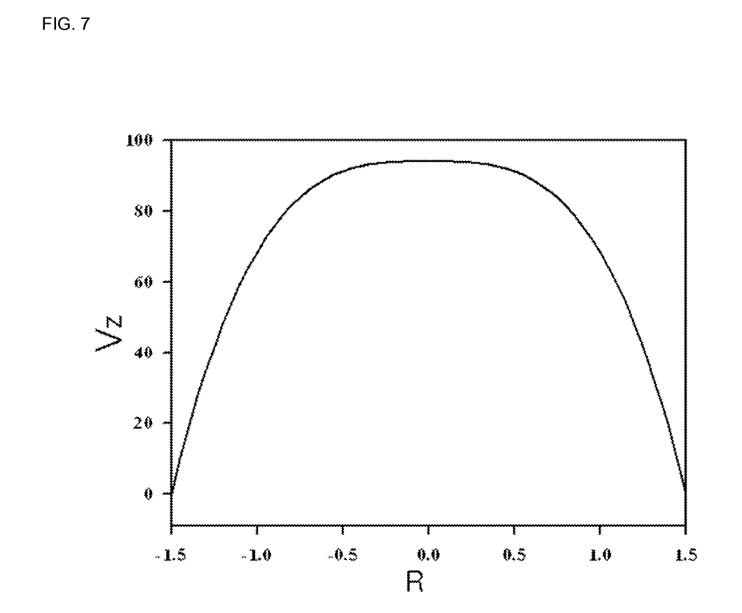

Describing a rate distribution Vz in the extrusion method using the extrusion apparatus according to the exemplary embodiment of the present invention, in case of an extrusions having a diameter of 3.0 mm, a laminar flow as illustrated in FIG. 7 is formed at a part adjacent to a wall surface of the extrusion path 221 due to frictional force and shearing force.

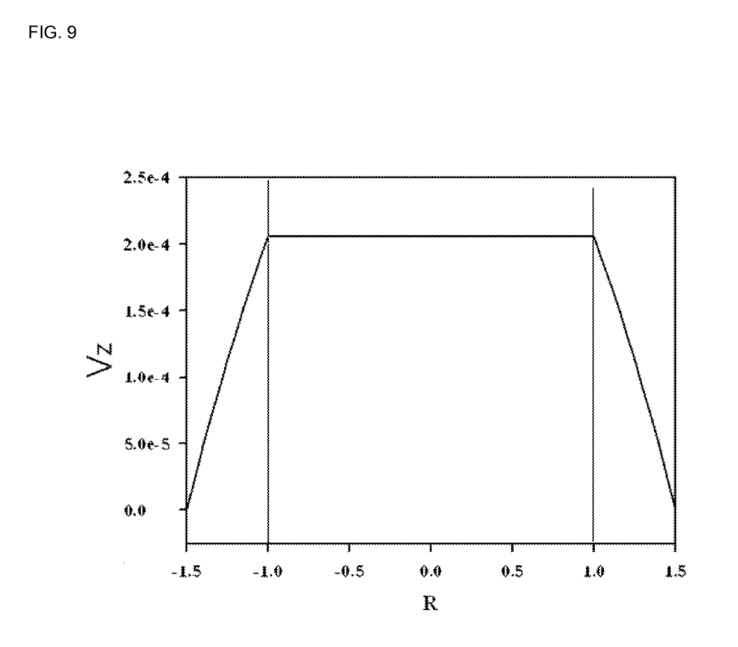

On the other hand, the apparatus 1 for continuously extruding polymer resin according to the exemplary embodiment of the present invention shows a rate distribution Vz in a flat flow form as illustrated in FIG. 9. When a diameter of the extrusion path 221 in the extrusion die 200 is 3.0 mm, oil absorbs the overall frictional force with the wall surface of the extrusion path 221 in the state in which a lubricant of about 0.5 mm is coated on the surface of the polymer resin melts, such that the polymer resin melts coated with the lubricant may be subjected to the extrusion working at a predetermined rate.

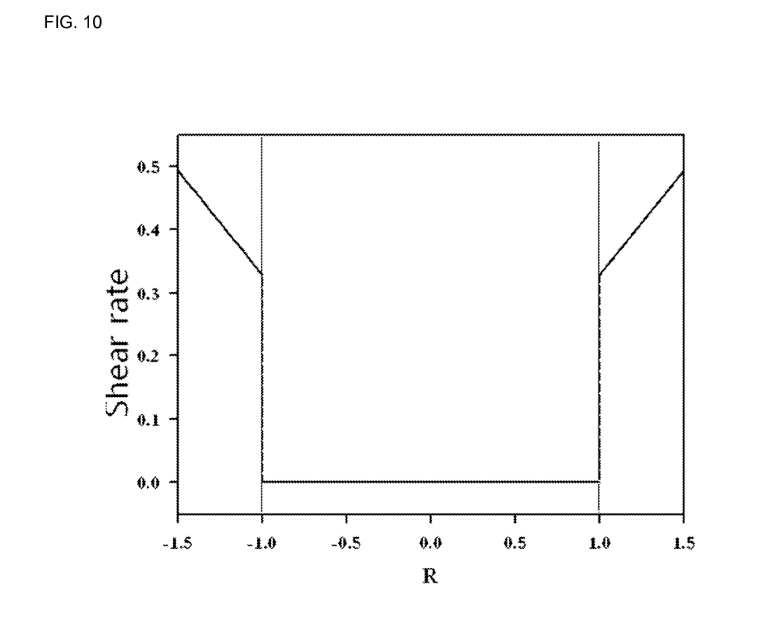

In particular, it can be appreciated from FIG. 10 that the apparatus 1 for continuously extruding polymer resin according to the exemplary embodiment of the present invention has a shear rate of the polymer resin melts much smaller than that of the oil coated on the surface and has a distribution largely different from the shear rate distribution in the extrusion apparatus according to the related art illustrated in FIG. 9.

Further, the apparatus 1 for continuously extruding polymer resin according to the exemplary embodiment of the present invention has a structure capable of evenly distributing the organic/inorganic coating materials into the extrusion die 200 in the method for continuously extruding polymer resin disclosed in Korean Patent Laid-Open Publication No. 2011-0110040 of the present applicant, thereby completely implementing the present invention.

Meanwhile, describing the method for continuously extruding polymer resin using the apparatus 1 for continuously extruding polymer resin according to the exemplary embodiment of the present invention includes: a) injecting polymer resin or a resin composition including additives into the extruder 100; b) transferring the polymer resin melts formed by melting the mixed composition in the barrel 140 to the extrusion die 200; and c) manufacturing an extrusion molding by extruding the polymer resin melts from the extrusion die 200 in the state in which the surface of the polymer resin melts is coated by the lubricant injected into the extrusion path 221 of the extrusion die 200.

In this case, in the method for continuously extruding polymer resin, it is preferable to completely form the shape of the extrusion molding and then remove the lubricant.

In the exemplary embodiment of the present invention, the polymer resin alone, one or more different polymer blend, or a mixture of polymer resin and additives may be used. All the polymers used in the extrusion process and other continuous processes may be used.

In detail, as the polymer resin, crystalline polymer, amorphous polymer, or a mixture thereof can be used.

A detailed example of the crystalline polymer may include polyethylene, polypropylene, polyvinyl acetate copolymer, polyester resin, nylon resin, and a copolymer thereof or blends including polymer resin including organic materials and the detailed example of amorphous polymer resin may be polyvinyl chloride, polystyrene, acrylic resin, polycarbonate, ABS, PAN, and a copolymer thereof or blends. In particular, an example of resin called rubber may include natural rubber, thermoplastic rubber such as SBR, BR, CR, IR, IIR, EPDM, and polyether, silicon rubber, and a copolymer thereof or blends.

Further, if necessary, additives generally used in the art may be added. The additives are generally added during the melting extrusion process or mean additives used to improve physical properties of polymer resin and a kind thereof is not limited. A detailed example may include a foaming agent, a pigment, an organic filler, an inorganic filler, a plasticizer, and the like, and the exemplary embodiment of the present invention is not limited thereto.

As the example of the exemplary embodiment of the present invention, polypropylene may be as the polymer resin. Such polypropylene-based resins having a melting temperature Tm of 130 to 170° C., an MI of 0.1 to 50, and a specific gravity of 0.8 to 1.0 has excellent extrusion machinability and is suitable to inject organic/inorganic materials, olygomer, and the like. The machinability may be improved by mixing other polymers with the polypropylene-based resin.

According to the exemplary embodiment of the present invention, the resin composition is melted and mixed during the continuous working in the extruder 100. During this process, the additives and the polypropylene-based resin are evenly mixed. In this case, preferably, the rotation rate of the extruding screw 130 may be 10 to 50 rpm in the extruder 100 and the extruded amount is 0.1 to 0.5 kg/h.

The exemplary embodiment of the present invention continuously extrudes and prepares the polymer resin at the melting temperature of polymer resin or from temperature lower than glass transition temperature to high temperature by coating an organic material, an inorganic material, or olygomer, and the like that are a poor solvent that has viscosity lower than that of the extrusions and is not solved in the polymer extrusions. In detail, the temperature of the die preferably satisfies the following Formulas 1 and 2.

Tm−60° C.=PT=Tm+300° C. [Formula 1]

Tg−10° C.=PT=Tg+350° C. [Formula 2]

(In the above Formulas 1 and 2, PT represents a temperature of polymer resin in the die, Tm represents a melting temperature of crystalline polymer resin, Tg represents glass transition temperature of amorphous polymer resin.)

In more detail, the polymer resin melts may be continuously extruded and prepared by the injection and coating of the organic/inorganic coating material in the vicinity of the relatively low temperature, that is, the transition temperature (in the case of crystalline polymer, the melting temperature Tm and in the case of the amorphous polymer, the glass transition temperature Tg) that are the conditions that the viscosity of polymer is increased in the die).

Therefore, the exemplary embodiment of the present invention can carry out the continuous extrusion in the range between Tm−60° C. and Tm+300° C. in which the viscosity of the polymer resin melts is expected to be increased and even in the range between Tg−10° C. and Tg+350° C.

As compared with performing the working in 50° C. or higher temperature equal to or than the melting temperature of resin in the existing general extrusion process, the extension of the range of the continuous extrusion process conditions is important for the exemplary embodiment of the present invention. The existing method keeps the temperature of resin in the extruder 100 at the melting temperature or higher, such that the physical properties of extrusions cannot bout have a limitation in polymer physical properties.

From the research results of the present inventors, the present inventors found that the above problems can be solved by a new method for coating the lubricant on the surface even in the very high viscosity of polymer resin or at the melting temperature or lower of polymer resin or in the vicinity thereof by injecting the low-viscosity organic/inorganic coating materials into the die and surprisingly, the polymer molding may be extruded and manufactured from the high-viscosity melt at low temperature to complete the present invention.

Therefore, the apparatus 1 for continuously extruding polymer resin can carry out the extrusion of the polymer resin melts having very high viscosity while carrying out the extrusion in the vicinity of the transition temperature of polymer resin or at the transition temperature or lower.

In addition, the apparatus 1 for continuously extruding polymer resin can improve the physical properties of the final extrusions since the resin temperature within the extruder 100 is not necessarily kept at the melting temperature or more and can variously change the die shape by reducing the die swell that is the decisive variable of the final extrusions.

The present invention is not limited to the aforementioned exemplary embodiment and an application range is various and it is apparent that various modifications can be made to those skilled in the art without departing from the spirit of the present invention described in the appended claims.

1. An apparatus 1 for continuously extruding polymer resin in a direction parallel with a flow direction thereof, comprising:
an extruder 100 including a barrel 140 having a hopper 110 disposed at one part thereof and an extrusion port 141 disposed at the other end thereof and an extrusion screw 130 rotatably disposed about a rotation shaft in the barrel 140; and
an extrusion die 200 connected with the extruder 100 so as to be injected with the polymer resin melts from the extruder 100 and discharging the polymer resin melts to a nozzle portion 300 through an extrusion path 221 formed by penetrating through the inside of the extrusion die 200,
herein a lubricant injected through an oil injection port 211 formed in the extrusion die 200 moves while coating a surface of the polymer resin melts flowing in the extrusion path 221.

2. The apparatus 1 for continuously extruding polymer resin of claim 1, wherein the extrusion die 200 includes:
a die body 210 including the oil injection port 211 disposed at one part thereof and a through hole 212 disposed therein and penetrated in a flow direction of the polymer resin melts;
a body insertion portion 220 formed in a cylindrical pipe shape to be inserted and coupled into the through hole 212 of the die body 210 and having the extrusion path 221 disposed therein, an oil flowing portion 222 formed to be radially depressed in a predetermined region of an outer circumferential surface, centered on a position at which the oil injection port 211 is formed, and an oil flowing hole 223 formed by making both ends of the oil flowing portion 222 in a hollow shape to move the oil to the extrusion path 221; and
a neck portion 230 including a communication hole 231 formed to penetrate through the inside thereof so as to communicate the extrusion port 141 of the extruder 100 with the extrusion path 221 and having one part coupled with the extrusion port 141 of the extruder 100 and the other part coupled with one end of the body insertion portion 220.

3. The apparatus 1 for continuously extruding polymer resin of claim 2, wherein the oil flowing portion 222 is adjacently formed to one end of the body insertion portion 220 disposed at a portion connected with the neck portion 230.

4. The apparatus 1 for continuously extruding polymer resin of claim 2, wherein the body insertion portion 220 is provided with a plurality of oil injection ports 211.

5. The apparatus 1 for continuously extruding polymer resin of claim 4, wherein the oil flowing portion 222 is depressed along an outer circumferential surface to pass through a position at which the oil injection port 211 is formed, and
at least two oil flowing holes 223 are formed.

6. The apparatus 1 for continuously extruding polymer resin of claim 2, further comprising:
an oil pump 400 inserted and coupled into the oil injection port 211 to supply oil at a predetermined pressure.

7. The apparatus 1 for continuously extruding polymer resin of claim 6, wherein the oil pump 400 is a gear pump or a plunger pump.

8. The apparatus 1 for continuously extruding polymer resin of claim 1, wherein the lubricant is water, silicon oil, ethylene glycol, canola oil, oligomer, or synthetic oil.
